(19) United States
(12) Patent Application Publication
(10) Pub. No.: US 2008/0134861 A1
(43) Pub. Date: Jun. 12, 2008

(54) Student Musical Instrument Compatibility Test

(76) Inventor: Bruce T. Pearson, Elk River, MN (US)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(21) Appl. No.: 11/537,344

(22) Filed: Sep. 29, 2006

(51) Int. Cl. G10H 1/02

(52) U.S. Cl. 84/470 R

(57) ABSTRACT

In some aspects, the invention involves assisting a user in choosing a musical instrument. User information may be gathered from the user, and a musical instrument compatibility recommendation may be generated and provided to the user. The user information can include eye-hand coordination information, musical idea ability information, instrument tonal preferences information, inner pulse information, personal information, or combinations thereof.

### TECHNICAL FIELD

This document relates to determining the compatibility of students and musical instruments.

### BACKGROUND

Students who learn to play musical instruments enjoy a variety of benefits. Music can be an important building block for excellence in other academic areas. Studies have shown a correlation between the study of music and brain development. Likewise, students who study music are often more likely to excel in reading. Perhaps even more importantly, students typically enjoy playing and listening to music, which can lead to increased creativity and reduced depression and anxiety. What is more, students who learn to play a musical instrument at a young age often set themselves on a life-long course of enjoying that instrument.

One reason why some students are not able to enjoy the benefits associated with playing a musical instrument is that they begin playing an instrument but soon grow frustrated with it and quit. This frustration often stems from the students' initially choosing instruments with which they are not compatible. Moreover, in many cases, it is not difficult to understand why a student would choose the wrong instrument. In many cases, the students are too young to possess the wisdom and judgment that would enable them to choose a suitable instrument, and their parents do not have the necessary expertise to account for all of the relevant factors.

For many years, band or orchestra instructors have counseled students in choosing musical instruments, but, in many cases, this counsel is inadequate. Often, the instructors are charged with instructing dozens of students and simply do not have the capacity to provide a detailed analysis to each student of all the variables that factor into choosing an instrument with which they are compatible. Moreover, some instructors who are able to provide detailed counsel to all students do not possess enough experience to account for all of the relevant factors in making a musical instrument compatibility recommendation.

In the past, some tests have been devised to ascertain a user's potential for becoming an accomplished musician. Examples of such tests include the Farnum Music Test by Stephen E. Farnum; the Music Aptitude Profile, the Primary Measures of Music Audiation, and the Intermediate Measures of Music Audiation by Edwin Gordon; Measures of Musical Abilities by Bentley; Seashore Measures of Musical Talents by Seashore et al.; and Standardized Tests of Musical Intelligence by Wing. Such tests are not, however, configured to match nearly all users—regardless of their potential to become great musicians—with musical instruments with which they are compatible.

### SUMMARY

In one aspect, the invention features a computer-readable medium that programmed with instructions for performing a method of assisting a user in choosing a musical instrument. The medium may include instructions for causing a programmable processor to gather user information from the user. The medium may include instructions for causing a programmable processor to generate a musical instrument compatibility recommendation based on the user information. The medium may include instructions for causing a programmable processor to provide the musical instrument compatibility recommendation to the user.

In a second aspect, the invention features a method of assisting a user in choosing a musical instrument. The method may include gathering user information from the user. The user information may include at least two of the following: eye-hand coordination information, musical idea ability information, instrument tonal preferences information, inner pulse information, and personal information. In some embodiments, gathering user information from the user can include administering one or more computer-implemented tests to the user. The method may include generating a musical instrument compatibility recommendation based on the user information. The method may include providing the musical instrument compatibility recommendation to the user.

In a third aspect, the invention features a system for assisting a first user in choosing a musical instrument. The system may include gathering means for gathering user information from the first user. The system may include recommending means for generating a first musical instrument compatibility recommendation based on the user information. The system may include providing means for providing the first musical instrument compatibility recommendation to the first user. The first user may be located at a first remote location and the gathering means may be located at a central location. The gathering means may be configured to gather user information from the first user via a network. The gathering means may be configured to gather user information from a second user, and the providing means may be configured to provide a second musical instrument compatibility recommendation to the second user. The second user may be located at a second remote location. The gathering means may include means for gathering eye-hand coordination, means for gathering musical idea ability information, means for gathering instrument tonal preferences information, means for gathering inner pulse information, and means for gathering personal information.

Implementations may include one or more of the following features. The user information may be quantified, and the musical instrument compatibility recommendation may based on the quantified user information. One or more recommendation rules can be applied to the quantified user information for purposes of generating the musical instrument compatibility recommendation. The one or more recommendation rules can be based on information from successful players of musical instruments. The musical instrument compatibility recommendation can include a recommendation encouraging the user to play a first musical instrument and/or a recommendation discouraging the user from playing a second musical instrument. The musical instrument compatibility recommendation can be provided to the user within approximately 30 minutes of the beginning of the user-information-gathering process.

The user information can include various kinds of information. The user information can include eye-hand coordination information. The user information can include musical idea ability information, which can include information related to the user's grasp of timbre, pitch, rhythm, volume, or combinations thereof. Gathering musical idea ability information can include subjecting the user to a repeated musical pattern followed by a single musical pattern and receiving the user's input as to whether the single musical pattern was the same as the repeated musical pattern. The user information can include instrument tonal preferences information. The user information can include inner pulse information. Gathering inner pulse information can include (a) subjecting the user to a series of sounds at an even pace, (b) following the series of sounds with a period of silence and then an indicator, and (c) receiving input from the user as to how many sounds would have played during the period of silence had the sounds continued at the even pace. The user information can include personal information. The personal information can include information related to the user's personality or character, the user's environment, the user's physical characteristics, or combinations thereof. Gathering information related to the user's personality or character can include gathering information related to the user's grades in school. Gathering information related to the user's environment can include gathering information related to the user's level of parental involvement. Gathering information related to the user's physical characteristics can include gathering information related to the shape of the user's mouth. The user information can include eye-hand coordination information, musical idea ability information, instrument tonal preferences information, inner pulse information, and personal information.

User information can be gathered in a variety of sequences. Eye-hand coordination information can be gathered before musical idea ability information. Musical idea ability information can be gathered before personal information. Musical idea ability information can be gathered before instrument tonal preferences information.

Embodiments of the present invention may have one or more of the following advantages. Some embodiments match users with one or more instruments with which they are most likely to be compatible. Some embodiments notify users of one or more instruments with which they are least likely to be compatible. Some embodiments take into account user information from multiple relevant categories, such as eye-hand coordination information, musical ideas ability information, instrument tonal preferences information, inner pulse information, and personal information. Some embodiments gather eye-hand coordination information from users quickly and efficiently. Some embodiments gather musical ideas ability information from users quickly and efficiently. Some embodiments gather musical ideas ability information based on users' recognition of trends among patterns of music rather than among individual notes. Some embodiments gather instrument tonal preferences information from users quickly and efficiently. Some embodiments gather inner pulse information from users quickly and efficiently. Some embodiments gather personal information from users quickly and efficiently. Some embodiments gather sub-categories of personal information, such as information related to the user's environment, information related to the user's personality and character, and information related to the user's physical attributes. Some embodiments are able to gather relevant user information and provide a corresponding instrument compatibility recommendation within a relatively short period of time (e.g., 30 minutes). Some embodiments administer user-information-gathering tests to users in a user-friendly sequence. Some embodiments gather user information based on a user's innate ability, as opposed to the user's acquired knowledge. In some embodiments, instructors can use instrument compatibility recommendations in allocating students to various instrument groups. Some embodiments reduce the number of instruments that are returned to stores that sell musical instruments. Some embodiments increase the number of people who have positive experiences with band and/or orchestra, thereby leading to a greater number of citizens who appreciate band and/or orchestra and act (e.g., vote) accordingly.

### BRIEF DESCRIPTION OF THE FIGURES

FIG. 1 is a functional diagram of a system for assisting users in selecting suitable musical instruments.

FIG. 2 is a functional diagram of a system similar to that of FIG. 1.

FIG. 3A is a more detailed functional diagram of a SMICT module.

FIG. 3B is a functional flow diagram that illustrates some of the functionality of the SMICT module of FIG. 3A.

FIG. 4 is a functional flow diagram that illustrates one example of a method for generating recommendation rules.

FIG. 5 is a functional flow diagram that illustrates one example of a method for verifying the accuracy of recommendation rules.

FIG. 6A is a functional diagram of an eye-hand coordination gatherer and an eye-hand coordination quantifier.

FIG. 6B shows an example of an eye-hand coordination test.

FIG. 7 is a functional diagram of a musical ideas ability gatherer and a musical ideas ability quantifier.

FIG. 8 is a functional diagram of a instrument tonal preferences gatherer and an instrument tonal preferences quantifier.

FIG. 9 is a functional diagram of an inner pulse gatherer and an inner pulse quantifier.

FIG. 10A is a functional diagram of a personal gatherer and a personal quantifier.

FIG. 10B shows how a personal test might ascertain information about the front shape of a user's mouth.

FIG. 10C shows how a personal test might ascertain information about the side profile of a user's mouth.

### DETAILED DESCRIPTION OF ILLUSTRATIVE EMBODIMENTS

The following detailed description of illustrative embodiments should be read with reference to the figures, in which like elements in different figures are numbered identically. The figures depict illustrative embodiments and are not intended to limit the scope of the invention. Rather, the present invention is defined solely by the claims.

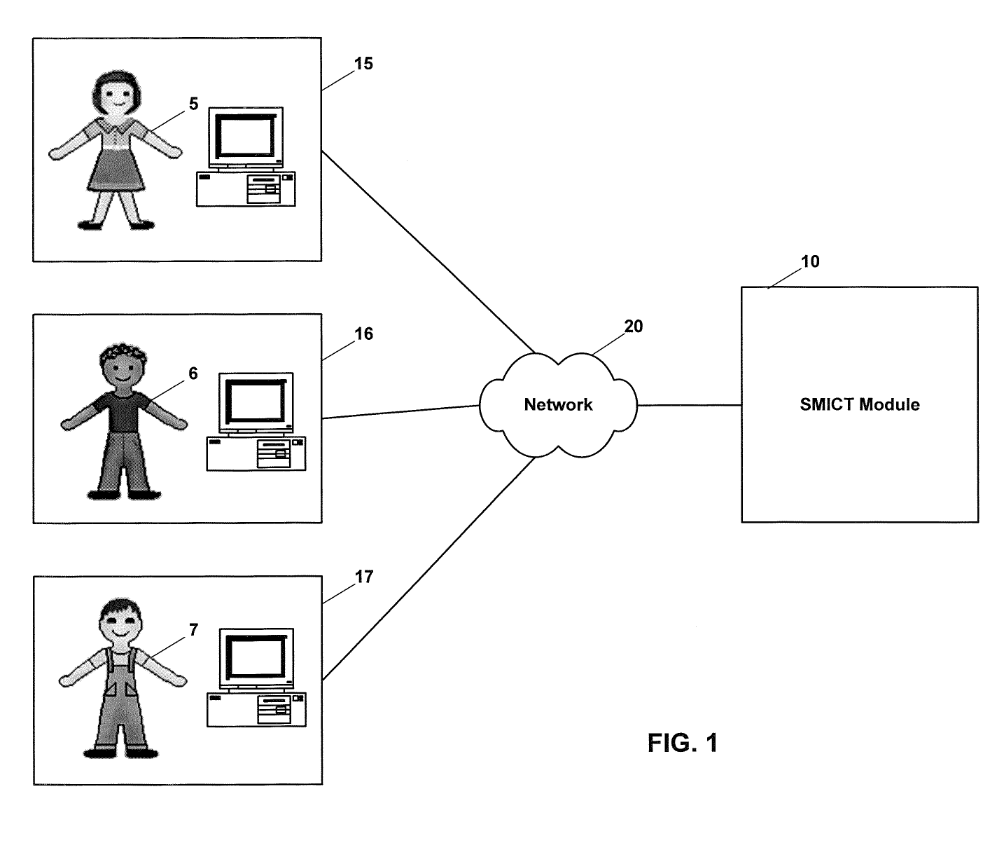

FIG. 1 is a functional diagram of a system for assisting users in selecting suitable musical instruments. Using this system, users 5, 6, 7 can provide information to a SMICT module 10 (SMICT stands for student musical instrument compatibility test), and the SMICT module 10 can provide instrument compatibility recommendations to the users 5, 6, 7 in return. Users 5, 6, 7 can be anyone interested in choosing an instrument, such as school-age children or adults. Users 5, 6, 7 can interact with the SMICT module 10 from separate remote locations 15, 16, 17. The SMICT module 10 can be located at a central location, which can differ from the remote locations 15, 16, 17, and the users 5, 6, 7 can interact with the SMICT module 10 via a network 20 (e.g., the Internet). In some embodiments, a copy of the SMICT module 10 can be located at each of the remote locations 15, 16, 17, thereby allowing the users 5, 6, 7 to interact with the SMICT module directly.

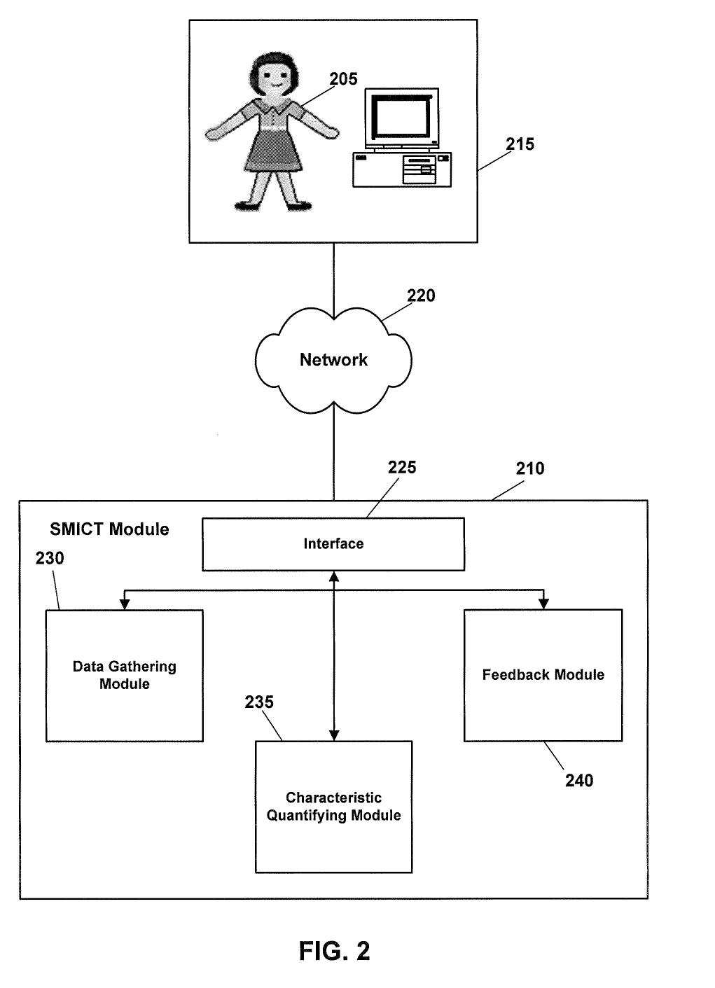

FIG. 2 is a functional diagram of a system similar to that of FIG. 1. A user 205 can interact with a centrally located SMICT module 210 from remote location 215 via a network 220. The SMICT module 210 can receive user information from the user 205 at an interface 225, which can allow components that are external to the SMICT module 210 to communicate with components that are internal to the SMICT module 210. The interface 225 can provide the user information to a data gathering module 230 (like all exchanges of information discussed herein, this exchange can be either “push” or “pull”). An example of user information would be that the user 205 answered 88 of 150 total questions on a standardized eye-hand coordination test, and that 64 of those 88 answers were correct. After receiving the proper user information from the interface 225, the data gathering module 230 can provide the user information to a characteristic quantifying module 235.

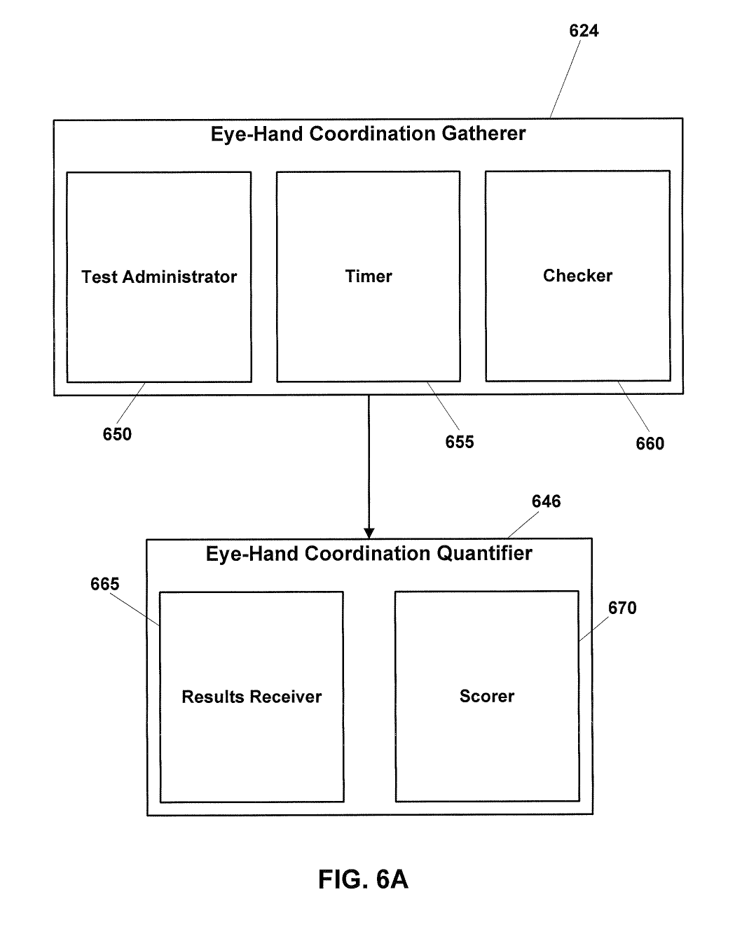

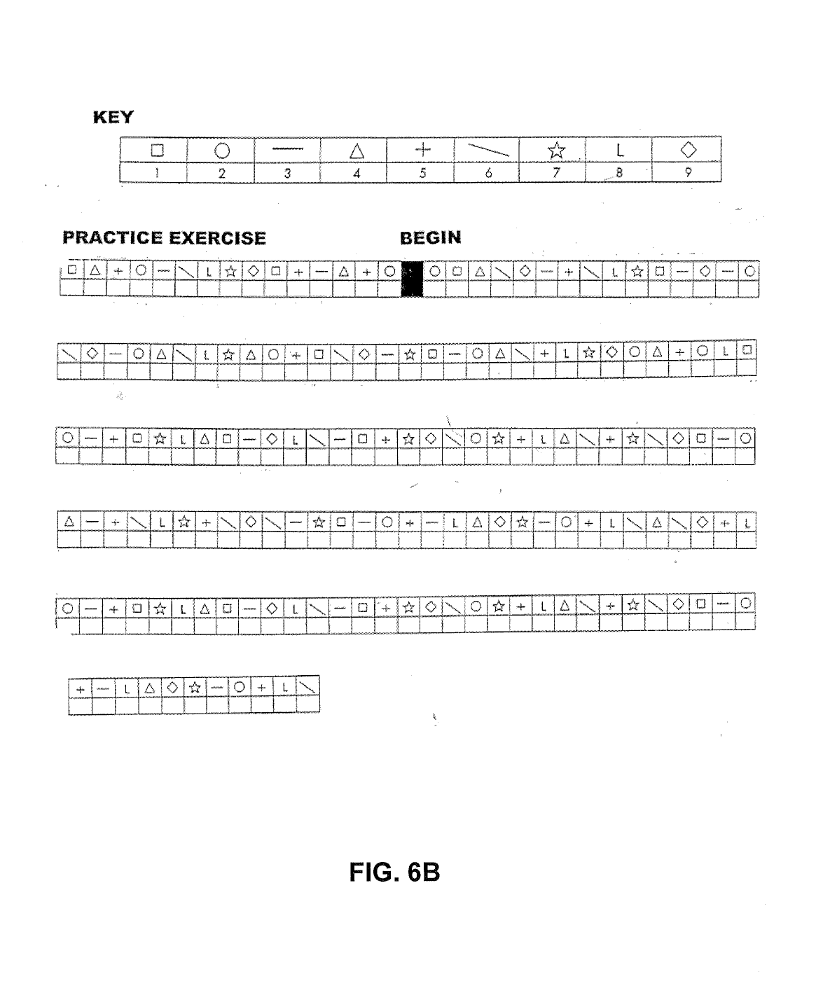

Having received the raw user information, the characteristic quantifying module 235 can quantify that information so that the SMICT module 210 can provide the user 205 with a compatibility recommendation based on it. For example, the characteristic quantifying module 235 could determine that 88 total answers and 64 correct answers on the standardized eye-hand coordination test ranked in the 73rd percentile of all users, giving the user 205 an eye-hand coordination score of 73. The data gathering and characteristic quantifying functionality is discussed in greater detail in connection with FIGS. 6A-10C. After the characteristic quantifying module 235 has quantified the user information, the characteristic quantifying module 235 can provide the quantified information to a feedback module 240.

Having received the quantified information, the feedback module 240 can generate an instrument compatibility recommendation and provide that instrument compatibility recommendation to the user 205. The feedback module 240 can retrieve one or more recommendation rules from a rule repository. For example, a recommendation rule might be, “Users with an eye-hand coordination score lower than 80 should probably avoid the violin.” The feedback module 240 can then apply the recommendation rules to the user information to generate an instrument compatibility recommendation. In the previous example, if the quantified information indicated that the user 205 had had an eye-hand coordination score of 73, the feedback module 240 could include, “You may wish to consider avoiding the violin,” as part of its instrument compatibility recommendation. After generating the instrument compatibility recommendation, the feedback module 240 can provide it to the user 205 through the interface 225 and the network 220.

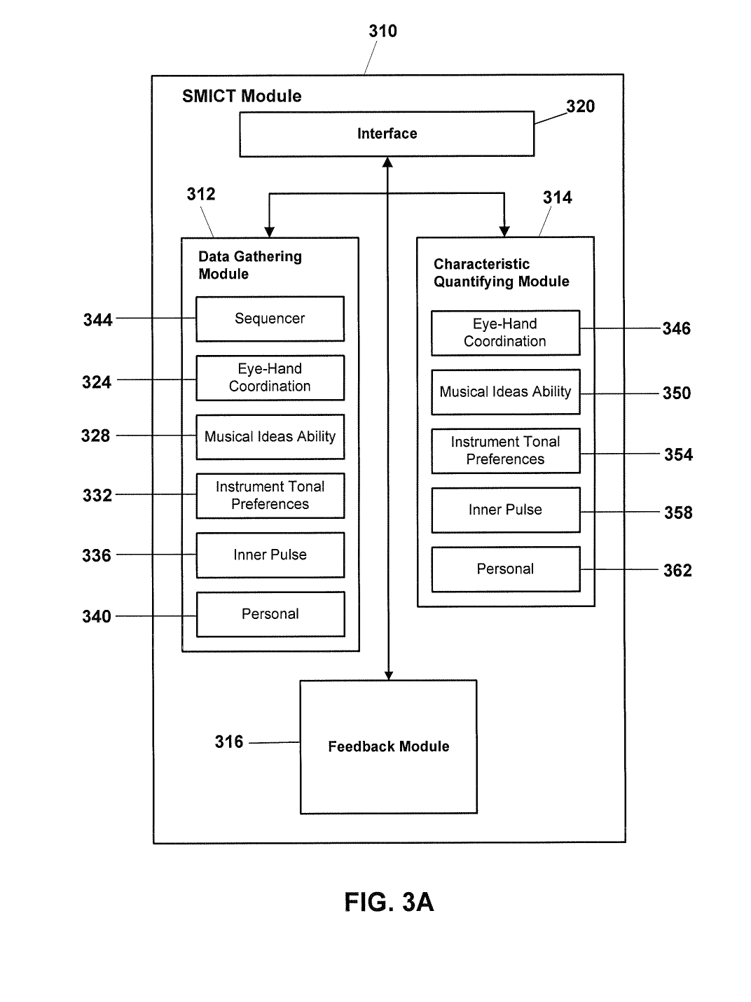

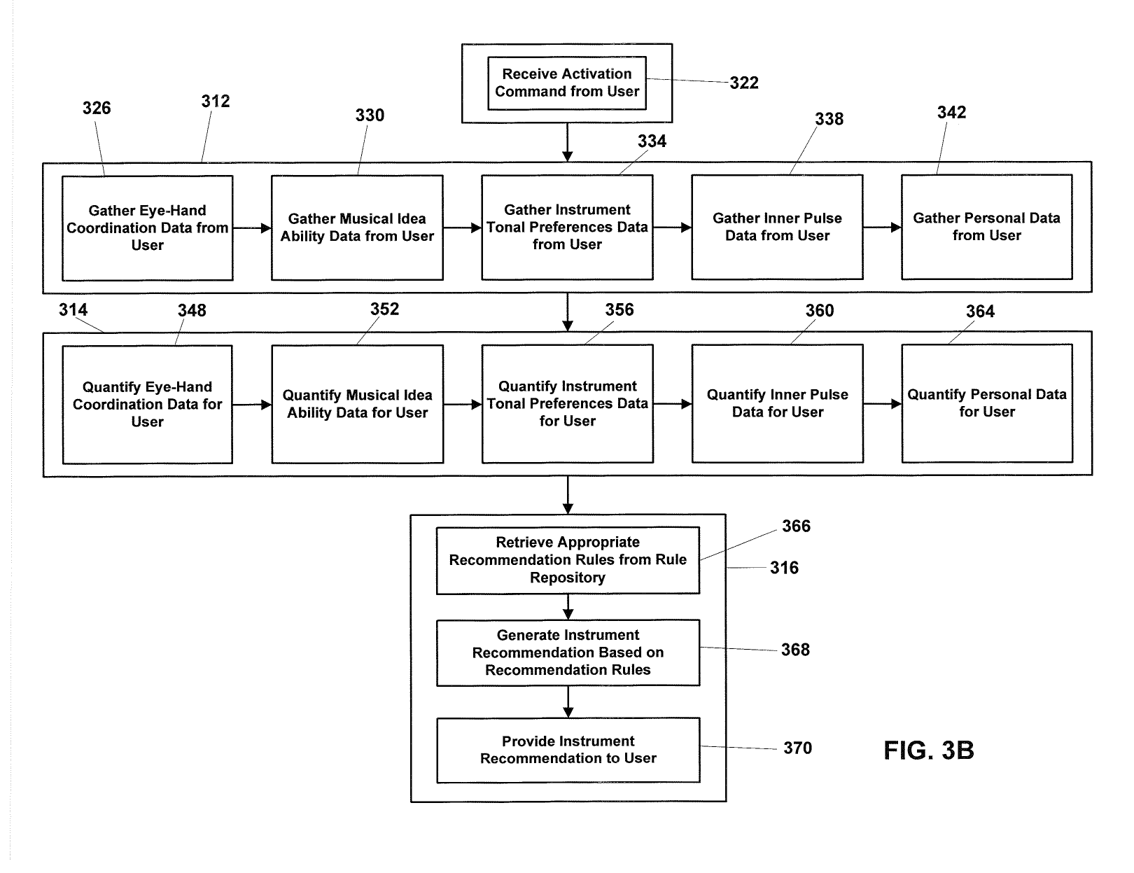

FIG. 3A is a more detailed functional diagram of a SMICT module 310, and FIG. 3B is a functional flow diagram that illustrates the functionality of the SMICT module 310 in some embodiments of the present invention. Like the SMICT module 210 of FIG. 2, the SMICT module 310 of FIGS. 3A-3B includes a data gathering module 312, a characteristic quantifying module 314, a feedback module 316, and an interface 320. In some embodiments, the SMICT module 310 is activated by receiving an activation command from a user (322).

Like the data gathering module of FIG. 2, the data gathering module 312 of FIG. 3A can be configured to gather user information from users through the interface 320. The data gathering module 312 of FIGS. 3A-3B is configured to gather five categories of user information: eye-hand coordination data, musical ideas ability data, instrument tonal preferences data, inner pulse data, and certain items of personal data. User information from these categories can impact whether users will be compatible with certain musical instruments. In some embodiments, like that of FIG. 3A, the SMICT module 310 can account for all of these categories of user information. In some embodiments, SMICT modules can account for only a portion of these categories in assessing user/instrument compatibility. Some SMICT module embodiments account for some combination of these categories of user information plus relevant user information from other similar categories.

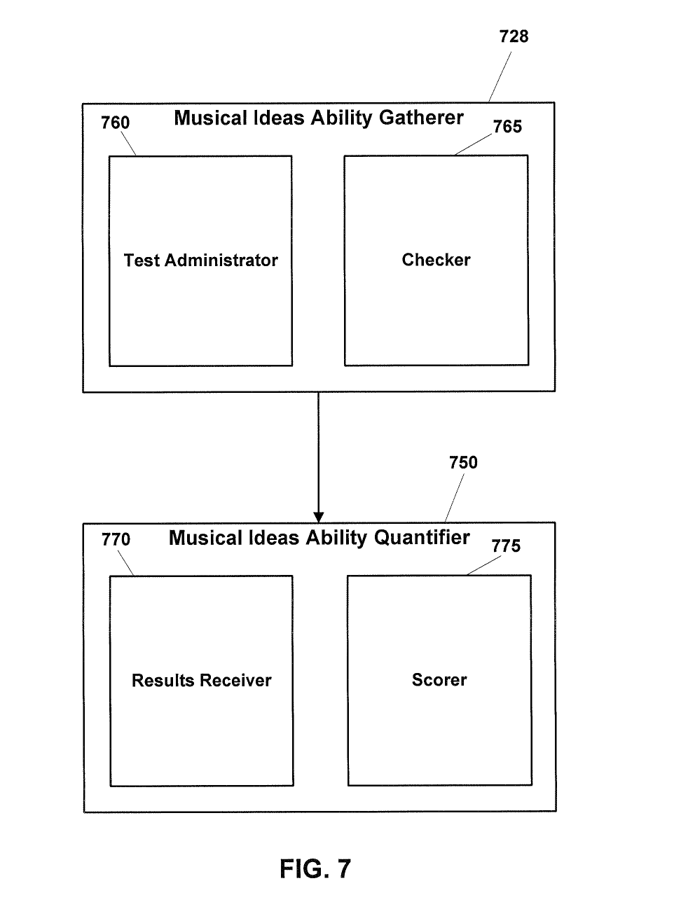

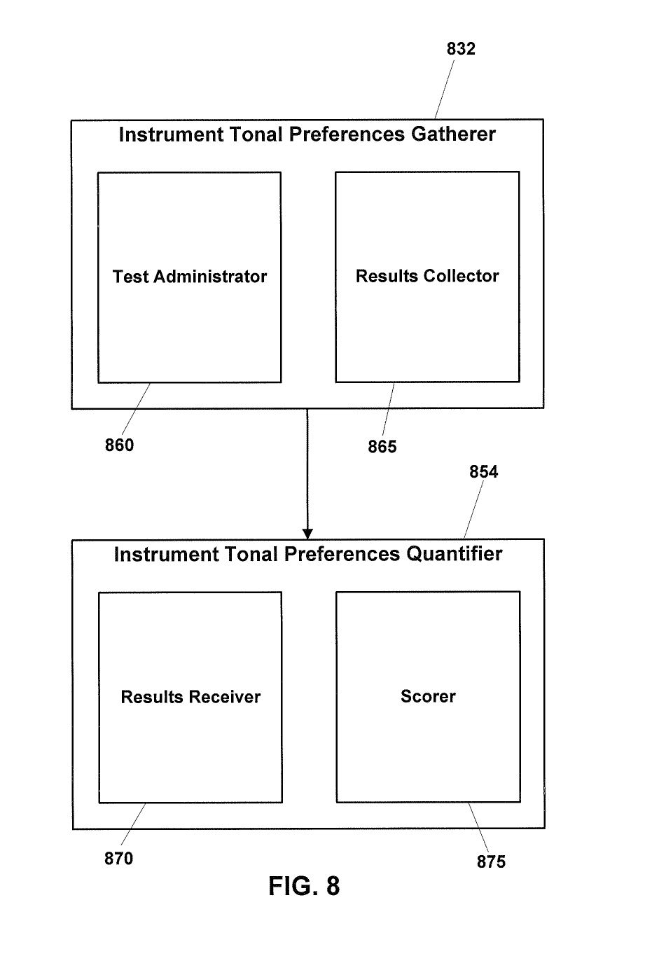

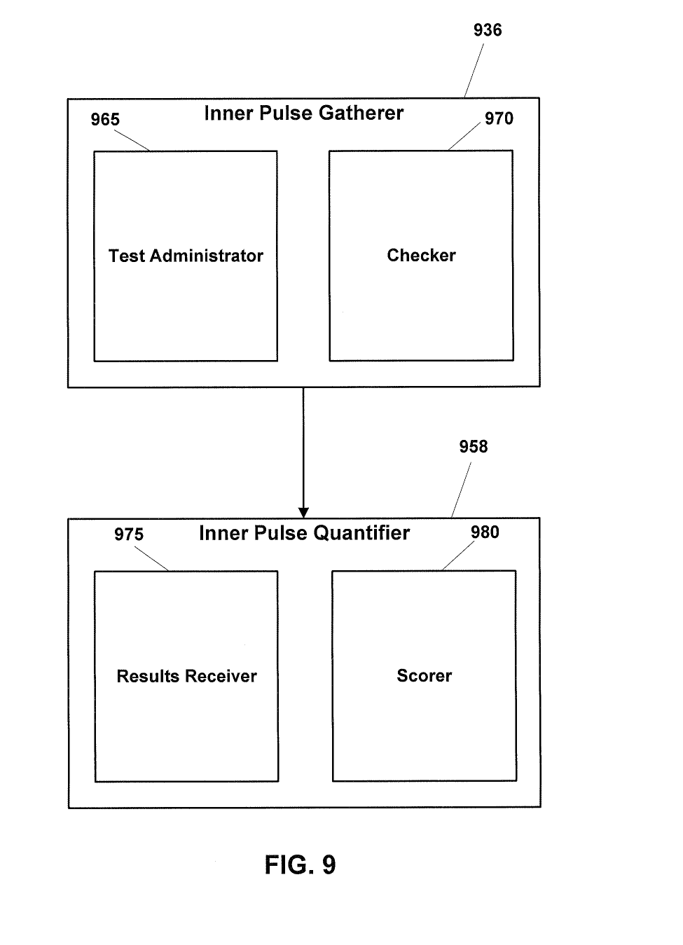

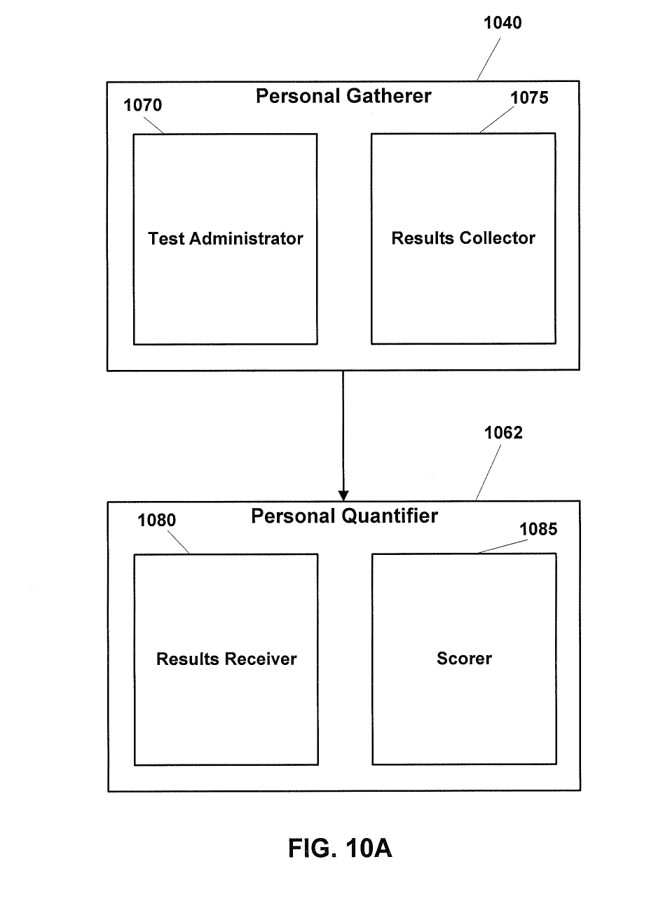

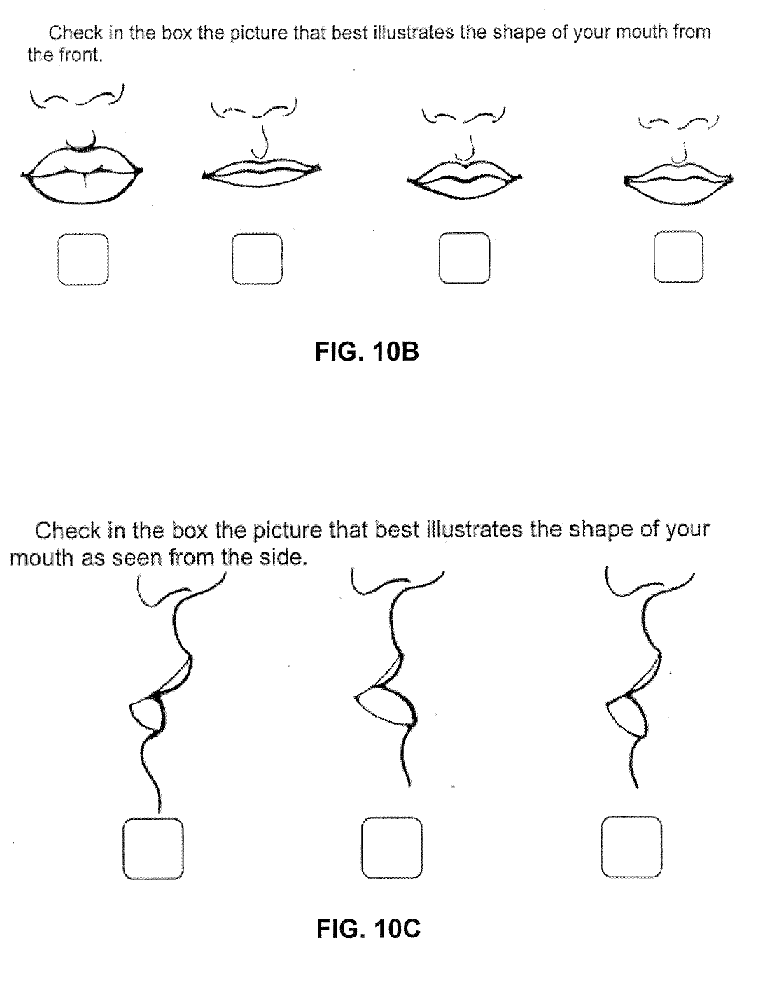

To gather user information from all of these categories, the data gathering module 312 can include several gatherers. An eye-hand coordination gatherer 324 can be configured to gather eye-hand coordination data from a user (326). An eye-hand coordination gatherer is discussed in greater detail in connection with FIGS. 6A-6B. A musical ideas ability gatherer 328, discussed in greater detail in connection with an embodiment in FIG. 7, can be configured to gather musical ideas ability data from the user (330). An instrument tonal preferences gatherer 332, discussed in greater detail in connection with an embodiment in FIG. 8, can be configured to gather instrument tonal preferences data from the user (334). An inner pulse gatherer 336, discussed in greater detail in connection with an embodiment in FIG. 9, can be configured to gather inner pulse data from the user (338). A personal gatherer 340, discussed in greater detail in connection with an embodiment in FIGS. 10A-10C, can be configured to gather personal data from the user (342). SMICT module embodiments configured to gather different categories of user information can include different gatherers. When the data gathering module 312 of FIGS. 3A-3B has gathered the proper user information from each of the five categories discussed above, the data gathering module 312 can provide that user information to the characteristic quantifying module 314.

Like the characteristic quantifying module of FIG. 2, the characteristic modifying module 314 of FIG. 3 can be configured to quantify user information gathered by the data gathering module 312 in order for the SMICT module 310 to make an instrument compatibility recommendation based on it. The characteristic quantifying module 314 of FIGS. 3A-3B includes a quantifier for each category of user information. An eye-hand coordination quantifier 346, discussed in greater detail in connection with an embodiment in FIGS. 6A-6B, can be configured to quantify eye-hand coordination data for the user (348). A musical ideas ability quantifier 350, discussed in greater detail in connection with an embodiment in FIG. 7, can be configured to quantify musical idea ability data for the user (352). An instrument tonal preferences quantifier 354, discussed in greater detail in connection with an embodiment in FIG. 8, can be configured to quantify instrument tonal preferences data for the user (356). An inner pulse quantifier 358, discussed in greater detail in connection with an embodiment in FIG. 9, can be configured to quantify inner pulse data for the user (360). A personal quantifier 362, discussed in greater detail in connection with an embodiment in FIGS. 10A-10C, can be configured to quantify personal data for the user (364). SMICT module embodiments configured to gather and quantify different categories of user information can include different quantifiers. When the characteristic quantifying module 314 of FIGS. 3A-3B has quantified the user information gathered by the data gathering module 312, the characteristic quantifying module 314 can provide that user information to the feedback module 316.

Like the feedback module of FIG. 2, the feedback module 316 of FIG. 3A can be configured to generate an instrument compatibility recommendation and provide that instrument compatibility recommendation to the user. The feedback module 316 can retrieve one or more recommendation rules from a repository (366). The feedback module 316 can then generate an instrument compatibility recommendation based on the recommendation rules (368). As is discussed above, the feedback module 316 can apply the recommendation rules to the quantified user information. After generating the instrument compatibility recommendation, the feedback module 316 can provide it to the user (370) through the interface 320.

The SMICT module 310 shown in FIGS. 3A-3B includes multiple components. Components designed to gather and quantify user information, to make compatibility recommendations based on that quantified user information, and to provide those compatibility recommendations to the user may include a greater or lesser number of components. In SMICT module embodiments, the functions performed by multiple components in the SMICT module 310 discussed herein may be combined into fewer components, such as one component. For example, a single component could both gather relevant user information and quantify that information rather than having both a data gathering module 312 and a characteristic quantifying module 314. In some SMICT module embodiments, the functions performed by one component in the SMICT module 310 discussed herein may be performed by multiple components. For example, the multiple functions of the feedback module 316 discussed herein may be performed by, e.g., a component configured to select the proper recommendation rule(s) from the rule repository, a component configured to apply the recommendation rule(s) to the quantified user information in order to generate an instrument compatibility recommendation, a component configured to provide the instrument compatibility recommendation to the user, and other miscellaneous components. Some SMICT module embodiments may include additional components to provide additional functionality. Components of SMICT modules may perform the functions discussed herein in various ways. The ways by which the components of the SMICT module 310 perform the functions discussed herein are provided only for illustration.

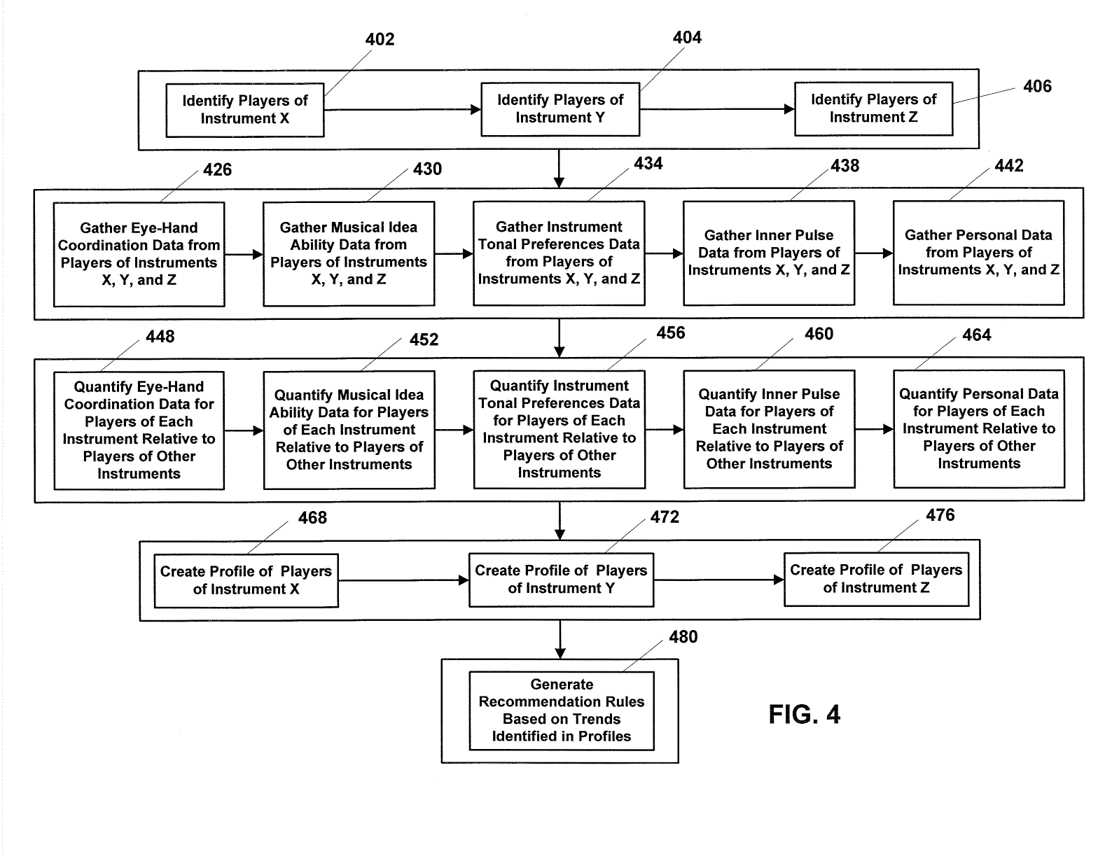

FIG. 4 is a functional flow diagram that illustrates one example of a method for generating recommendation rules that can be accessed by SMICT modules in some embodiments of the present invention. In many embodiments, generating recommendation rules involves creating profiles of successful players of various instruments (i.e., players who are compatible with their instruments) and drawing conclusions based on trends identified within and among those profiles. For purposes of illustration, the method of FIG. 4 involves generating recommendation rules associated with players of instruments X, Y, and Z. Examples of instruments X, Y, and Z include instruments commonly found in a band or orchestra. In some instances, recommendation rules can be generated that correspond to many different instruments. For example, in many instances, recommendation rules can be generated that correspond to every instrument in a standard band and/or orchestra.

In the method of FIG. 4, the first step is to identify a group of successful players of every instrument for which recommendation rules are to be generated. Accordingly, in keeping with the illustration introduced above, groups of successful players of instrument X, successful players of instrument Y, and successful players of instrument Z are identified (402), (404), (406). The number of players per group can be determined based on understood principles of statistics.

With the groups of successful players of instruments X, Y, and Z identified, successful player data can be gathered from, and quantified for, all of the players in all of the instrument groups. A software module can be configured to perform the gathering and quantifying functions. The software module can include components like the data gathering module 312 and the characteristic quantifying module 314 of FIGS. 3A-3B. Referring again to FIG. 4, the successful player data can be from the same categories as the user information discussed above. In many embodiments, the successful player data is gathered and quantified in the same way as the user information is to be gathered and quantified by the SMICT module. In such embodiments, the user information and the successful player data can be readily compared for purposes of making accurate instrument compatibility recommendations to users. With that in mind, eye-hand coordination data, musical idea ability data, instrument tonal preferences data, inner pulse data, and personal data can be gathered from players of instruments X, Y, and Z (426), (430), (434), (438), (442). Likewise, that data can be quantified for players of each instrument relative to players of other instruments (448), (452), (456), (460), (464). An example of what the quantified successful player data can look like is provided in the following table (see FIGS. 8 and 10, and the corresponding discussion, for an explanation of instrument tonal preferences scores and personal scores that can be used in some embodiments):

| | In- | Eye-Hand | Musical | Instrument | | |
|---|---|---|---|---|---|---|
| | stru- | Co- | Ideas | tonal | Inner | |
| Name | ment | ordination | Ability | preferences | Pulse | Personal |
| Player 1 | X | 88 | 47 | 211 | 83 | 243 |
| Player 2 | Z | 18 | 97 | 111 | 21 | 152 |
| Player 3 | Z | 33 | 60 | 322 | 39 | 445 |
| Player 4 | Y | 80 | 9 | 132 | 64 | 551 |
| Player 5 | Y | 21 | 24 | 331 | 88 | 555 |
| Player 6 | X | 93 | 17 | 123 | 99 | 515 |
| Player 7 | X | 80 | 51 | 222 | 90 | 323 |
| Player 8 | Y | 56 | 42 | 333 | 14 | 553 |
| Player 9 | Z | 12 | 65 | 212 | 57 | 251 |
| Player 10 | Y | 44 | 36 | 131 | 37 | 552 |
| Player 11 | Z | 57 | 81 | 313 | 48 | 423 |
| Player 12 | X | 75 | 29 | 213 | 85 | 121 |
| Player 13 | Z | 40 | 73 | 231 | 75 | 341 |
| Player 14 | Y | 43 | 32 | 232 | 79 | 554 |
| Player 15 | X | 77 | 19 | 311 | 87 | 355 |

Of course, successful player data is usually collected from more than 15 players in order to create profiles. This table is provided only for purposes of illustration. As is mentioned above, the number of successful players necessary for creating viable profiles can be determined based on understood principles of statistics.

After the successful player data is gathered and quantified, profiles can be created of players of instruments X, Y, and Z (468), (472), (476). One example of a profile for a player of instrument X, based on the quantified successful player data from the table above, has an eye-hand coordination value of greater than 75, a musical ideas ability value of 32.6 (with a relatively large standard deviation), an indeterminate instrument tonal preferences value (because the first number, which indicates the successful player's response to instrument X's sound, holds to no discernable pattern for players of instrument X), an inner pulse value of greater than 83, and an indeterminate personal value (because the three numbers, which are indicative of the successful player's environment, the successful player's personality/character, and the successful player's physical attributes, hold to no discernable pattern for players of instrument X). Also based on the quantified successful player data from the table above, one example of a profile for a player of instrument Y has an eye-hand coordination value of 48.8 (with a relatively large standard deviation), a musical ideas ability value of 28.6 (also with a relatively large standard deviation), an instrument tonal preferences value having 3 as its second number (indicating that a typical successful player of instrument Y strongly likes the sound of instrument Y), an inner pulse value of 56.4 (again, with a relatively large standard deviation), and a personal value having 5 as its first and second number (indicating that a typical successful player of instrument Y has a very supportive environment and a very strong personality/character). One example of a profile for a player of instrument Z, likewise based on the quantified successful player data from the table above, has an eye-hand coordination value of 32 (with a relatively large standard deviation), a musical ideas ability value of greater than 60, an indeterminate instrument tonal preferences value (because the third number, which indicates the successful player's response to instrument Z's sound, holds to no discernable pattern for players of instrument Z), an inner pulse value of 48 (again, with a relatively large standard deviation), and an indeterminate personal value (because the three numbers hold to no discernable pattern for successful players of instrument X). Of course, profiles can take a variety of forms and can include various kinds of information in a variety of levels of detail.

After profiles of players of instruments X, Y, and Z are created, recommendation rules can be generated based on trends identified in those profiles (480). In some instances, trends can be identified within the profile of a single instrument player. For example, using the illustrative profiles set forth above, the following recommendation rules can be generated: (a) users whose eye-hand coordination value is less than 75 should consider avoiding instrument X; (b) users whose musical idea ability value is less than 60 should consider avoiding instrument Z; (c) users whose instrument tonal preferences value does not have 3 as its second number should consider avoiding instrument Y; (d) users whose inner pulse value is less than 83 should consider avoiding instrument X; and (e) users whose personal value does not have 5 as its first and second numbers should consider avoiding instrument Y. In some instances, trends can be identified among the profiles of multiple instrument players. For example, using the illustrative profiles set forth above, the following recommendation rules can be generated: (f) users can feel free to play instruments Y and Z no matter what their eye-hand coordination value is; (g) users can feel free to play instruments X and Y no matter what their musical ideas ability value is; (h) users can feel free to play instruments X and Z no matter what their instrument tonal preferences value is; (i) users can feel free to play instruments Y and Z no matter what their inner pulse value is; and (j) users can feel free to play instruments X and Z no matter what their personal value is. Recommendation rules can come in a variety of forms with varying levels of specificity, depending on the number of instruments involved, the underlying profiles, and several other relevant factors. In many embodiments, when the recommendation rules are generated, they can be stored in a rule repository that is accessible to a SMICT module.

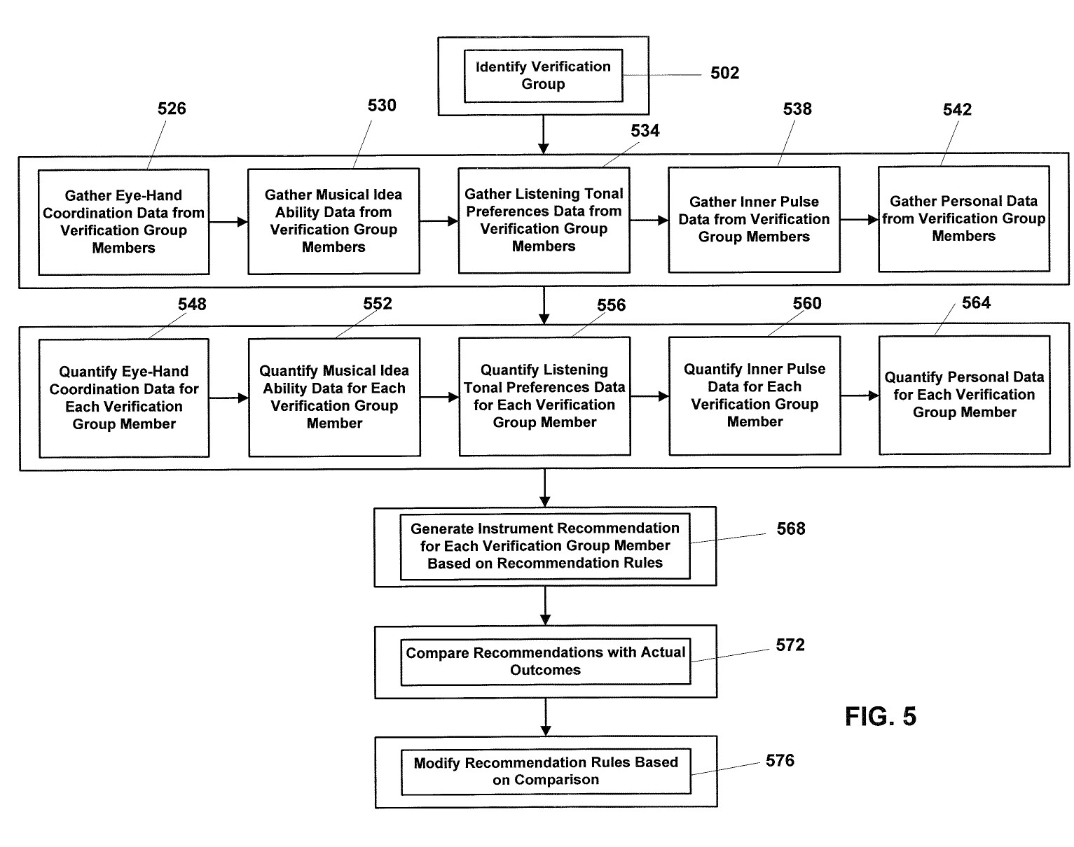

FIG. 5 is a functional flow diagram that illustrates one example of a method for verifying the accuracy of recommendation rules. In some embodiments, the recommendation rules can be verified before being made accessible to a SMICT module. In some embodiments, the recommendation rules can be verified by applying them to quantified data from a random group of people, some of whom have proven to be compatible with their instruments and some of whom have proven to be incompatible with their instruments. In such embodiments, if the recommendation rules produce instrument compatibility recommendations that are consistent with the players' experiences (e.g., recommending that a person avoid an instrument with which he or she has proven to be incompatible, recommending that a person choose an instrument with which he or she has proven to be compatible, etc.), the recommendation rules' accuracy can be verified. On the other hand, in such embodiments, if the recommendation rules produce instrument compatibility recommendations that are inconsistent with the players' experiences (e.g., recommending that a person avoid an instrument with which he or she has proven to be compatible, recommending that a person choose an instrument with which he or she has proven to be incompatible, etc.), the recommendation rules may need to be modified. The method of FIG. 5 is one example of how recommendation rules can be verified.

In the method of FIG. 5, the first step is to identify a verification group (502). As is mentioned above, the verification group can include a mixture of people who have proven to be compatible with their instruments and people who have proven to be incompatible with their instruments. In some embodiments, the group can consist of students who selected an instrument roughly one year before participating in the verification process. In some such embodiments, the students who have proven to be compatible with their instruments can be those who exceed a predetermined score on an objective test, and the students who have proven to be incompatible with their instruments can be those who do not exceed the predetermined score. In some such embodiments, anecdotal comments by a student's teacher can impact whether he or she is deemed compatible with his or her instrument. To continue with the example set forth in FIG. 4, suppose that the verification group consists of people have proven to be compatible or incompatible with instruments X, Y, or Z.

With the verification group identified, verification data can be gathered from, and quantified for, all members of the verification group. A software module can be configured to perform the gathering and quantifying functions. The software module can include components like the data gathering module 312 and the characteristic quantifying module 314 of FIGS. 3A-3B. Referring again to FIG. 5, the verification data can be gathered and quantified in the same way as the successful player data was gathered and quantified in generating the recommendation rules. With that in mind, eye-hand coordination data, musical idea ability data, instrument tonal preferences data, inner pulse data, and personal data can be gathered from members of the verification group (526), (530), (534), (538), (542). Likewise, that data can be quantified for members of the verification group (548), (552), (556), (560), (564).

With verification data gathered and quantified for each member of the verification group, instrument compatibility recommendations can be generated for each verification group member based on the established recommendation rules (568). For example, if a verification group member had an eye-hand coordination value of 76, a musical idea ability value of 89, an instrument tonal preferences value of 312, an inner pulse value of 49, and a personal value of 253, the instrument compatibility recommendation, based on the illustrative recommendation rules set forth above, would encourage the verification group member to play instrument Z. The instrument compatibility recommendation would not encourage the verification group member to play instrument X because of rule (d) set forth above, nor would it encourage the verification group member to play instrument Y because of rules (c) and (e) set forth above. Instrument compatibility recommendations such as this can be generated for each member of the verification group.

The instrument compatibility recommendations for each member of the verification group can then be compared with the actual outcomes (572). If an instrument compatibility recommendation comports with the actual experience of a verification group member, the instrument compatibility recommendation can be deemed a good one, lending greater credibility to the recommendation rule(s) on which the instrument compatibility recommendation was based. On the other hand, if an instrument compatibility recommendation conflicts with the actual experience of a verification group member, the instrument compatibility recommendation can be deemed a bad one, calling into question the recommendation rule(s) on which the instrument compatibility recommendation was based. In the example discussed above, if the verification group member had proven to be compatible with instrument Z, the instrument compatibility recommendation could be deemed a good one, which can increase confidence in rules (a)-(f) and (h)-(j) set forth above. On the other hand, if the verification group member had proven to be incompatible with instrument Z, the instrument compatibility recommendation could be deemed a bad one, perhaps leading to the re-evaluation of one or more of rules (a)-(f) and (h)-(j) set forth above. If the verification group member had proven to be compatible or incompatible with either instrument X or instrument Y, the recommendation rules on which the instrument compatibility recommendation was based could be analyzed further based on the verification group member's quantified data.

Finally, based on the comparison between the instrument compatibility recommendations for the verification group members and their actual outcomes, the recommendation rules can be modified if necessary (576). The comparison can produce a variety of information about the recommendation rules, and the modifications can be made based on a variety of factors.

Referring again to FIGS. 3A-3B, a user could interact with the SMICT module 310 to determine whether to select instrument X, instrument Y, or instrument Z, and the SMICT module 310 could be configured to access recommendation rules (a)-(j) discussed in the preceding paragraphs. Suppose the characteristic quantifying module 314 determined that the user had an eye-hand coordination value of 92, a musical idea ability value of 54, an instrument tonal preferences value of 223, an inner pulse value of 85, and a personal value of 341. The feedback module 316 would access recommendation rules (a)-(e), (g)-(h), and (j) discussed above and generate an instrument compatibility recommendation encouraging the user to play instrument X. The feedback module 316 would then provide that instrument compatibility recommendation to the user via the interface 320.

FIG. 6A is a functional diagram of an eye-hand coordination gatherer 624 and an eye-hand coordination quantifier 646 that can be used in some embodiments of the present invention. The eye-hand coordination gatherer 624 and the eye-hand coordination quantifier 646 can be similar to those of FIG. 3A.

The eye-hand coordination gatherer 624 of FIG. 6A is configured to gather eye-hand coordination data from users by administering a test to the users. The eye-hand coordination gatherer 624 includes a test administrator 650, which can be configured to cause an eye-hand coordination test, along with suitable instructions, to be displayed to the user. In some embodiments, the test administrator 650 provides materials to the user audibly. In some such embodiments, audible materials are provided instead of visible materials. In some embodiments, users can interact directly with the test administrator 650 by entering answers to the test into input fields provided by the test administrator 650. In some embodiments, users can record their answers with pen and paper and then correct their tests manually. In such embodiments, users can provide their test results to the eye-hand coordination gatherer 624.

FIG. 6B shows an example of an eye-hand coordination test. In the test of FIG. 6B, users are to enter numbers in the blanks provided below the symbols according to the key. Users can be given a relatively short period of time (e.g., 30 seconds) to perform the practice exercise and a relatively long period of time (e.g., 2 minutes) to perform the regular exercise. A user's eye-hand coordination can be assessed based on how many blanks the user filled in and how many of those filled-in blanks were accurate according to the key.

Referring again to FIG. 6A, the eye-hand coordination gatherer 624 can include a timer 655. The timer 655 can keep track of the time allotted to a user in taking the eye-hand coordination test. In some embodiments, the timer 655 can “unlock” input fields when the test has begun and “lock” input fields when the test is completed, thereby assuring that the user uses only the time allotted in completing the test. In some embodiments, the timer 655 can cause the time remaining in the test to be displayed to the user. In some embodiments, the timer 655 can trigger a notification (e.g., audible and/or visible) to the user that a designated period of time remains for completing the test. The timer 655 can perform many other useful functions that are known in the art.

The eye-hand coordination gatherer 624 of FIG. 6A includes a checker 660. The checker 660 can be configured to determine how the user fared on the eye-hand coordination test. In some embodiments, the checker 660 checks the answers inputted by the user against the key. In such embodiments, the checker 660 can check the user's answers for speed, for accuracy, or for both. For example, using the test of FIG. 6B as an example, the checker 660 may check a user's answers and determine that he or she filled in 90 of 150 blanks and that 72 of those 90 were accurate. In this example, the checker 660 can provide a speed value of, e.g., 90 and an accuracy value of, e.g., 80 (72/90=80%) to the eye-hand coordination quantifier 646.

The eye-hand coordination quantifier 646 of FIG. 6A receives the speed value and the accuracy value from the checker 655 at a results receiver 665. The results receiver 665 can provide those results to a scorer 670, which can assign an eye-hand coordination score to the user based on how the user's results compared to those of his or her peers. For example, if the user is in fifth grade, the scorer 670 can compare the user's results to those of other fifth graders. Continuing with the previous example, the scorer 670 could determine that the user's speed value of 90 was in the 67th percentile, leading to a speed score of 90, and that the user's accuracy value of 80 was in the 79th percentile, leading to an accuracy score of 79. The scorer 670 could then combine the two scores to create a composite eye-hand coordination score. For example, the scorer 670 could average 67 and 79 to get an eye-hand coordination score of 73. The scorer 670 could then provide the eye-hand coordination score of 73 to a feedback module, which could generate an instrument compatibility recommendation and provide it to the user as discussed in connection with FIGS. 2, 3A, and 3B.

Referring again to FIG. 6A, recommendation rules concerning a user's eye-hand coordination typically follow a familiar pattern. Typically, good eye-hand coordination is important for playing the flute, the clarinet, the oboe, the violin, the snare drum, and other similar instruments. On the other hand, eye-hand coordination is not as critical for playing the trombone, the euphonium, the tuba, and other similar instruments.

FIG. 7 is a functional diagram of a musical ideas ability gatherer 728 and a musical ideas ability quantifier 750 that can be used in some embodiments of the present invention. The musical ideas ability gatherer 728 and the musical ideas ability quantifier 750 can be similar to those of FIG. 3A.

The musical ideas ability gatherer 728 of FIG. 7 is configured to gather musical ideas ability data from users by administering a test to the users. The musical ideas ability gatherer 728 includes a test administrator 760, which can be configured to cause a musical ideas ability test, along with suitable instructions, to be administered to the user. The test administrator 760 of FIG. 7 can have the same or similar functionality to that of FIG. 6A.

Referring again to FIG. 7, musical ideas ability tests can take a variety of forms. Many embodiments test a user's innate grasp of timbre, pitch, rhythm, and volume. Some embodiments test a user's innate grasp of other similar musical ideas, such as harmony and texture. To test the user's innate grasp of musical ideas, the test can begin by subjecting a user to a repeated musical pattern (e.g., repeated three times) followed by a single musical pattern and then asking the user whether the single musical pattern was the same as or different from the repeated musical pattern. Using musical patterns, as opposed to single notes, can allow the test to gauge the user's mental ability to understand musical ideas (“the processor”) rather than simply gauging how well the user is able to hear various notes (“the sensors”) (though some embodiments can use individual notes). For example, to test a user's innate grasp of timbre, the repeated pattern could be: honk-beep-beep-beep. That pattern could be repeated three times, and then there could be a pause. Following the pause, the user could hear: beep-beep-honk-beep. The user would be asked whether the single pattern was the same or different. In this example, the correct answer would be: different. To test a user's innate grasp of pitch, the repeated pattern could be: high-high-low-low. And the single pattern could be: high-high-low-low. In this example, the correct answer would be: same. To test a user's innate grasp of rhythm, the repeated pattern could be: fast-slow-fast-slow. And the single pattern could be: fast-slow-slow-fast. In this example, the correct answer would be: different. To test a user's innate grasp of volume, the repeated pattern could be: soft-soft-soft-loud. And the single pattern could be: soft-soft-soft-loud. In this example, the correct answer would be: same. In some embodiments, the musical ideas ability test can include three patterns designed to test for timbre, three patterns designed to test for pitch, three patterns designed to test for rhythm, and three patterns designed to test for volume. A user's musical ideas ability can be assessed based on how many of the single musical patterns the user is able to correctly identify as being the same as or different from the corresponding repeated musical patterns.

The musical ideas ability gatherer 728 of FIG. 7 includes a checker 765, which can have the same or similar functionality as that of FIG. 6A. Referring again to FIG. 7, the checker 765 can check the user's answers for timbre aptitude, pitch aptitude, rhythm aptitude, and volume aptitude. For instance, using the example discussed above that included three sets of patterns for each musical idea, the checker 765 may check the user's answers and determine that the user answered correctly in 1 out of 3 timbre questions, 3 out of 3 pitch questions, 0 out of 3 rhythm questions, and 2 out of 3 volume questions. In such instance, the checker 765 can provide a timbre value of, e.g., 1, a pitch value of, e.g., 3, a rhythm value of, e.g., 0, and a volume value of, e.g., 2 to the musical ideas ability quantifier 750.

The musical ideas ability quantifier 750 of FIG. 7 receives the timbre value, the pitch value, the rhythm value, and the volume value from the checker 765 at a results receiver 770. The results receiver 770 can provide those results to a scorer 775, which can assign a musical ideas ability score to the user based on how the user's results compared to those of his or her peers. Continuing with the previous example in which the user had a timbre value of 1, a pitch value of 3, a rhythm value of 0, and a volume value of 2, the scorer 775 could determine, e.g., that the user's timbre value was in the 27th percentile, the user's pitch value was in the 99th percentile, the user's rhythm value was in the 3rd percentile, and the user's volume value was in the 55th percentile. The scorer 775 could then combine the four scores to create a composite musical ideas ability score. For example, the scorer 775 could average 27, 99, 3, and 55 to get a musical ideas ability score of 46. The scorer 775 could then provide the musical ideas ability score of 46 to a feedback module, which could generate an instrument compatibility recommendation and provide it to the user as discussed in connection with FIGS. 2, 3A, and 3B.

FIG. 8 is a functional diagram of an instrument tonal preferences gatherer 832 and an instrument tonal preferences quantifier 854 that can be used in some embodiments of the present invention. The instrument tonal preferences gatherer 832 and the instrument tonal preferences quantifier 854 can be similar to those of FIG. 3A.

The instrument tonal preferences gatherer 832 of FIG. 8 is configured to gather instrument tonal preferences data from users by administering a test to the users. The instrument tonal preferences gatherer 832 includes a test administrator 860, which can be configured to cause an instrument tonal preferences test, along with suitable instructions, to be administered to the user. The test administrator 860 can have the same or similar functionality to that of FIG. 6A.

Referring again to FIG. 8, instrument tonal preferences tests can take a variety of forms. Some instrument tonal preferences tests can be designed to determine whether a user likes or dislikes several different types of instruments. In some embodiments, a user hears a melody (e.g., a 2-bar melody) played by an instrument and is then asked to choose his or her response to the melody from the following choices: definitely dislike, moderately dislike, slightly dislike, slightly like, moderately like, and definitely like. In some embodiments, the user hears twelve melodies by twelve different instruments and is then asked to choose his or her response from the above choices. In some such embodiments, the melody is kept constant. A user's instrument tonal preferences can be determined based on his or her responses to the melodies.

The instrument tonal preferences gatherer 832 of FIGS. 8 includes a results collector 865. The results collector 865 can be configured to collect the user's responses to the melodies played by the test administrator 860 on the instrument tonal preferences test. For example, using the example discussed above that included playing the same two-bar melody twelve times with twelve different instruments and asking the user to describe his or her response from the six choices, the results collector 865 may determine that the user responded as follows: moderately disliked sound #1; definitely disliked sound #2; slightly liked sound #3; moderately disliked sound #4; definitely liked sound #5; definitely liked sound #6; moderately liked sound #7; slightly liked sound #8; slightly disliked sound #9; slightly liked sound #10; definitely disliked sound #11; and moderately disliked sound #12. The results collector 865 can provide the instrument tonal preferences test results to the instrument tonal preferences quantifier 854.

The instrument tonal preferences quantifier 854 of FIG. 8 receives the user's instrument tonal preferences from the results collector 865 at a results receiver 870. The results receiver 870 can provide those results to a scorer 875, which can assign an instrument tonal preferences score to the user based on the user's preferences. For example, the instrument tonal preferences score could have twelve digits—one for each sound in the instrument tonal preferences test—with the following choices corresponding to the following numbers: definitely dislike=1; moderately dislike=2; slightly dislike=3; slightly like=4; moderately like=5; and definitely like=6. Using this system to assign a score to the user in the previous example would produce an instrument tonal preferences score of 214266543412. The scorer 875 could then provide the instrument tonal preferences score of 214266543412 to a feedback module, which could generate an instrument compatibility recommendation and provide it to the user as discussed in connection with FIGS. 2, 3A and 3B.

Referring again to FIG. 8, recommendation rules concerning a user's instrument tonal preferences typically follow a familiar pattern. Typically, if a user indicates that he or she definitely dislikes the sound of an instrument, he or she will be discouraged from playing that instrument. Conversely, if a user indicates that he or she definitely likes the sound of an instrument, he or she will often be encouraged to play that instrument. In many embodiments, the instrument tonal preferences test will not expose the user to every instrument he or she could potentially choose. In such embodiments, the instrument tonal preferences test can expose the user to instruments that are representative of other instruments. In this way, if a user strongly likes or dislikes an instrument from the instrument tonal preferences test, it can be inferred that he or she will likewise strongly like or dislike a larger group of instruments.

FIG. 9 is a functional diagram of an inner pulse gatherer 936 and an inner pulse quantifier 958 that can be used in some embodiments of the present invention. The inner pulse gatherer 936 and the inner pulse quantifier 958 can be similar to those of FIG. 3A.

The inner pulse gatherer 936 of FIG. 9 is configured to gather inner pulse data from users by administering a test to the users. The inner pulse gatherer 936 includes a test administrator 965, which can be configured to cause an inner pulse test, along with suitable instructions, to be administered to the user. The test administrator 965 can have the same or similar functionality to that of FIG. 6A.

Referring again to FIG. 9, inner pulse tests can come in a variety of forms. Many inner pulse tests are designed to determine whether the user has the innate ability to maintain the pace for others, such as for an entire band or orchestra. This ability differs from the innate ability to recognize patterns in rhythm, an ability that can be tested as part of a musical ideas test (see FIG. 7 and corresponding discussion). In some embodiments, the user hears six tones at a steady beat and then hears silence for a period of time, followed by a chord. During the period of silence, the user is to count at the same speed as the first six tones until hearing the chord. After the chord, the test asks the user the question, “On what count was the chord sounded?” If the user counted “7, 8, 9, 10” and heard the chord on 10, the user would answer 10. In some embodiments, the user is subjected to 12 series of tones, silence, and a chord, along with 12 corresponding questions. The pace of the tones can be varied, the duration of silence can be varied, and so on. Using this example of an inner pulse test, a user's inner pulse can be assessed based on how many of the 12 questions he or she answered correctly.

The inner pulse gatherer 936 of FIG. 9 includes a checker 970, which can have the same or similar functionality as that of FIG. 6A. Referring again to FIG. 9, using the inner pulse test discussed above as an example, the checker 970 may check the user's answers and determine that the user answered 7 out of 12 questions correctly. The checker 970 can provide an inner pulse test value of, e.g., 7 to the inner pulse quantifier 958.

The inner pulse quantifier 958 of FIG. 9 receives the inner pulse test value from the checker 970 at a results receiver 975. The results receiver 975 can provide those results to a scorer 980, which can assign an inner pulse score to the user based on how the user's inner pulse test value compared to those of his or her peers. Continuing with the previous example, the scorer 980 could determine, e.g., that the user's inner pulse test value of 7 was in the 58th percentile, resulting in an inner pulse score of, e.g., 58. The scorer 980 could then provide the inner pulse score of 58 to a feedback module, which could generate an instrument compatibility recommendation and provide it to the user as discussed in connection with FIGS. 2, 3A, and 3B.

Referring again to FIG. 9, recommendation rules concerning a user's inner pulse typically follow a familiar pattern. Often, good inner pulse is important for playing percussion instruments, tuba, stringed bass, bassoon, bass clarinet, and other similar instruments. On the other hand, inner pulse is not as critical for flute, clarinet, saxophone, and other similar instruments.

FIG. 10A is a functional diagram of a personal gatherer 1040 and a personal quantifier 1062 that can be used in some embodiments of the present invention. The personal gatherer 1040 and the personal quantifier 1062 can be similar to those of FIG. 3A. Referring again to FIG. 10A, the personal gatherer 1040 can be configured to gather personal data from a user, and the personal quantifier 1062 can be configured to quantify that data.

The personal gatherer 1040 of FIG. 10A is configured to gather personal data from users by administering a test to the users. The personal gatherer 1040 includes a test administrator 1070, which can be configured to cause a personal test, along with suitable instructions, to be administered to the user. The test administrator 1070 can have the same or similar functionality to that of FIG. 6A.

Personal tests can take a variety of forms. In some embodiments, personal tests can be used to determine personal characteristics about the user, such as the user's personality and/or character. Some personal tests try to ascertain the user's determination (e.g., by asking about the user's grades in school) because some instruments tend to require a higher level of determination (e.g., flute, oboe, clarinet, bassoon, etc.). Some personal tests try to ascertain the user's reading ability (e.g., by asking about the user's reading group in school) because some instruments tend to require a higher reading ability (e.g., flute, oboe, clarinet, bassoon, percussion, etc.). Some personal tests try to ascertain the level of parental involvement in the user's life (e.g., by asking how often the user's parents attend parent/teacher conferences) because some instruments tend to require a greater degree of encouragement during initial periods of difficulty (e.g., oboe, bassoon, French horn, etc.). Some personal tests try to ascertain the user's socioeconomic status because some instruments cost more to buy and to maintain (e.g., oboe, bassoon, French horn, saxophone, etc.). Some personal tests try to ascertain the user's choice of music (e.g., classical, musical shows/movie soundtracks, jazz/big band, pop/rock, country/western, etc.) because some instrument choices will limit the user's opportunities to play certain kinds of music (e.g., choosing to play the flute will likely not open up opportunities for the user to play in a rock band or a jazz band). Some personal tests try to ascertain the user's parents' choice of music because parents may be more likely to encourage their children to practice when they enjoy the sound. Some personal tests try to ascertain whether the user has any experience playing other instruments. Some personal tests may try to ascertain how introverted or extroverted the user is (e.g., by asking the user to rank himself or herself on a sliding scale) because players of some instruments tend to play more solos (e.g., oboe, trumpet, etc.).

Some personal tests are designed to gather information about the user's physical characteristics. For example, FIG. 10B shows how a personal test might ascertain information about a user's mouth as seen from the front. Certain lip formations are more conducive to compatibility with certain instruments. For example, a user having a lip formation like the one on the far left or the one second to the right could have difficulty playing the flute given the shape of the flute's opening in the head joint. FIG. 10C shows how a personal test might ascertain information about the side profile of a user's mouth. For example, a user having an underbite could have difficulty playing the clarinet. Some personal tests may ask whether the user's front teeth show when he or she smiles because such a mouth formation may limit the user's instrument options. Some personal tests may ask how long the user's right arm is because, e.g., users having shorter arms may have to use a special type of trombone or flute. Some personal tests may ask for the size of the user's fingertip (e.g., by asking whether the user's fingertip completely covers a circle displayed to the user) because some instruments have relatively large finger holes (e.g., clarinet, oboe, etc.). Some personal tests may ask whether the user currently wears, or intends to wear, braces. Personal tests may be designed to ascertain any physical characteristic that may prove relevant to determining whether a user is compatible with a particular instrument.

The personal gatherer 1040 of FIG. 10 includes a results collector 1075. The results collector 1075 can be configured to collect the user's responses to the personal inquiries. For example, the results collector 1075 could ascertain that the user (a) gets average grades at school, (b) is in the middle reading group at school, (c) has parents who always attend parent/teacher conferences, (d) enjoys country music very much, (e) has thin lips, (f) has an underbite, (g) has long arms, and (h) is very outgoing. The results collector 1075 can provide the personal test results to the personal quantifier 1062.

The personal quantifier 1062 of FIG. 10 receives the user's personal test results from the results collector 1075 at a results receiver 1080. The results receiver 1080 can provide those results to a scorer 1085, which can assign a personal score to the user based on the user's personal data. For example, the personal score could have eight digits—one for each data category in the personal test—with the following responses corresponding to the following numbers: (a) average grades=2 (below average=1 and above average=3); (b) middle reading group=2 (lowest reading group=1 and highest reading group=3); (c) above average parental involvement=3 (below average=1 and average=2); (d) country music preference=5 (classical=1, musicals/soundtracks=2, jazz/big band=3, and pop/rock=4); (e) thin lips=2 (the lips of FIG. 10B numbered from left to right); (f) underbite=2 (the mouth profiles of FIG. 10C numbered from left to right); (g) long arms=3 (short arms=1 and average length arms=2); and (h) very outgoing=9 (scoring from 0 to 9 with 0 being the most introverted and 9 being the most extroverted). Using this system to assign a score to the user in the previous example would produce a personal score of 22352239. The scorer 1085 could then provide the personal score of 22352239 to a feedback module, which could generate an instrument compatibility recommendation and provide it to the user as discussed in connection with FIGS. 2, 3A, and 3B.

The gatherers and quantifiers shown in FIGS. 6A, 7-9, and 10A include multiple components. Modules configured to gather and quantify user data may include a greater or lesser number of components. In some embodiments, the functions performed by multiple components as discussed herein may be combined into fewer components, such as one component. For example, in some embodiments, a single component can both administer tests and check/collect the results rather than having both a test administrator and a checker/results collector. In some embodiments, a single component can both administer tests and perform some of the timing functions rather than having both a test administrator and a timer. In some embodiments, a single component can both receive test results and generate composite scores rather than having both a results receiver and a scorer. In some embodiments, a single test administrator can administer multiple types of tests rather than having a separate test administrator for each type of test. In some embodiments, a single component can both gather and quantify user data rather than having both a gatherer and a quantifier. Many additional variations are possible.

In some embodiments, the functions performed by one component as discussed in connection with FIGS. 6A, 7-9, or 10A or elsewhere herein may be performed by multiple components. For example, in some embodiments, the multiple functions of a gatherer that is configured to gather all sub-categories of a category of user information (e.g., timbre aptitude, pitch aptitude, rhythm aptitude, and volume aptitude being sub-categories of musical ideas aptitude) could be performed by separate gatherers for each sub-category. In some embodiments, the multiple functions of a scorer discussed herein may be performed by, e.g., a component configured to compare the user's test results with that of his or her peers, a component configured to generate a composite score for the user for a given category of user information (possibly based on scores from sub-categories), a component configured to provide the composite score to a feedback module, and other miscellaneous components. In some embodiments, the multiple functions of test administrators discussed herein may be performed by, e.g., a component configured to supply the audio aspects of tests, a component configured to supply the video aspects of tests, a component configured to perform the other functions of the test administrator, and other miscellaneous components. Many additional variations are possible.

Some gatherer or quantifier embodiments may include additional components to provide additional functionality. Components of gatherers and quantifiers may perform the functions discussed herein in various ways. The ways by which the components of the gatherers and quantifiers of FIGS. 6A, 7-9, and 10A discussed herein are provided only for illustration.

Referring again to FIG. 3A, the sequencer 344 can determine the sequence in which the various gatherers are activated. In some embodiments, the sequencer 344 is configured to activate the gatherers in a sequence that is conducive to gathering information from users in the most user-friendly way possible, which may lead to more accurate user information. For example, in some embodiments, the eye-hand coordination test serves as a good warm-up, allowing the user to become engaged with the series of tests that comprise the student musical instrument compatibility test without becoming intimidated. In some embodiments, the musical ideas ability test follows the eye-hand coordination test because the musical ideas ability test tends to be the most intellectually rigorous test and users are able to handle it best when their minds are relatively fresh. In some embodiments, the musical ideas ability test is followed by the instrument tonal preferences test, the inner pulse test, and the personal test in order to make the student musical instrument compatibility test more enjoyable and less intimidating for users after the intellectually rigorous musical ideas ability test. In some embodiments, the sequencer 344 can activate the gatherers in a random sequence. Many additional sequence variations are possible.

As used in this document, the term “computer” means a device, or multiple devices working together, that accepts information (in the form of digitalized data) and manipulates it for some result based on a program or sequence of instructions on how the data is to be processed. A computer may also include the means for storing data for some necessary duration.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications, or code) include machine instructions for a programmable processor, and can be implemented in a high-level procedural and/or object-oriented programming language, and/or in assembly/machine language. As used herein, the term “computer-readable medium” refers to any computer program product, apparatus and/or device (e.g., magnetic discs, optical disks, memory, Programmable Logic Devices (PLDs)) used to provide computer instructions and/or data to a programmable processor, including a computer-readable medium that receives computer instructions as a computer-readable signal. The term “computer-readable signal” refers to any signal used to provide computer instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back-end component (e.g., as a data server), or that includes a middleware component (e.g., an application server), or that includes a front-end component (e.g., a client computer having a graphical user interface or a Web browser through which a user can interact with an implementation of the systems and techniques described here), or any combination of such back-end, middleware, or front-end components. The components of the system can be interconnected by any form or medium of digital data communication (e.g., a communication network). Examples of communication networks include a LAN, a WAN, and the Internet.

The computing system can include clients and servers. A client and server are generally remote from each other and typically interact through a communication network. The relationship of client and server arises by virtue of computer programs running on the respective computers and having a client-server relationship to each other.

Thus, embodiments of the student musical instrument compatibility test are disclosed. One skilled in the art will appreciate that the student musical instrument compatibility test can be practiced with embodiments other than those disclosed. Any of the functionality discussed herein may be incorporated into a method, a system, a computer-readable medium, a device, and so on. The disclosed embodiments are presented for purposes of illustration and not limitation, and the present invention is limited only by the claims that follow.

What is claimed is:

1. A computer-readable medium programmed with instructions for performing a method of assisting a user in choosing a musical instrument, the medium comprising instructions for causing a programmable processor to:
gather user information from the user;
generate a musical instrument compatibility recommendation based on the user information; and
provide the musical instrument compatibility recommendation to the user.

2. The medium of claim 1, further comprising instructions for causing the programmable processor to quantify user information, thereby creating quantified user information, wherein generating the musical instrument compatibility recommendation is based on the quantified user information.

3. The medium of claim 2, wherein generating the musical instrument compatibility recommendation comprises applying one or more recommendation rules to the quantified user information.

4. The medium of claim 3, wherein the one or more recommendation rules are based on information from successful players of musical instruments.

5. The medium of claim 1, wherein the user information comprises eye-hand coordination information.

6. The medium of claim 1, wherein the user information comprises musical idea ability information.

7. The medium of claim 6, wherein the musical idea ability information comprises information related to the user's grasp of timbre, pitch, rhythm, volume, or combinations thereof.

8. The medium of claim 6, wherein gathering musical idea ability information comprises subjecting the user to a repeated musical pattern followed by a single musical pattern and receiving the user's input as to whether the single musical pattern was the same as the repeated musical pattern.

9. The medium of claim 1, wherein the user information comprises instrument tonal preferences information.

10. The medium of claim 1, wherein the user information comprises inner pulse information.

11. The medium of claim 10, wherein gathering inner pulse information comprises (a) subjecting the user to a series of sounds at an even pace, (b) following the series of sounds with a period of silence and then an indicator, and (c) receiving input from the user as to how many sounds would have played during the period of silence had the sounds continued at the even pace.

12. The medium of claim 1, wherein the user information comprises personal information.

13. The medium of claim 12, wherein the personal information comprises information related to the user's personality or character, the user's environment, the user's physical characteristics, or combinations thereof.

14. The medium of claim 13, wherein gathering information related to the user's personality or character comprises gathering information related to the user's grades in school.

15. The medium of claim 13, wherein gathering information related to the user's environment comprises gathering information related to the user's level of parental involvement.

16. The medium of claim 13, wherein gathering information related to the user's physical characteristics comprises gathering information related to the shape of the user's mouth.

17. The medium of claim 1, wherein the user information comprises eye-hand coordination information, musical idea ability information, instrument tonal preferences information, inner pulse information, and personal information.

18. The medium of claim 17, wherein eye-hand coordination information is gathered before musical idea ability information.

19. The medium of claim 17, wherein musical idea ability information is gathered before personal information.

20. The medium of claim 1, wherein the musical instrument compatibility recommendation comprises a recommendation encouraging the user to play a first musical instrument.

21. The medium of claim 20, wherein the musical instrument compatibility recommendation further comprises a recommendation discouraging the user from playing a second musical instrument.

22. The medium of claim 1, further comprising instructions for causing the programmable processor to finish providing the musical instrument compatibility recommendation to the user within approximately 30 minutes of beginning to gather user information from the user.

23. A method of assisting a user in choosing a musical instrument, comprising:
gathering user information from the user, the user information comprising at least two of the following: eye-hand coordination information, musical idea ability information, instrument tonal preferences information, inner pulse information, and personal information;
generating a musical instrument compatibility recommendation based on the user information; and
providing the musical instrument compatibility recommendation to the user.

24. The method of claim 23, wherein the user information comprises eye-hand coordination information, musical idea ability information, instrument tonal preferences information, inner pulse information, and personal information

25. The method of claim 23, wherein gathering user information from the user comprises administering one or more computer-implemented tests to the user.

26. The method of claim 23, wherein the musical idea ability information comprises information related to the user's grasp of timbre, pitch, rhythm, volume, or combinations thereof.

27. The method of claim 23, wherein the personal information comprises information related to the user's personality or character, the user's environment, the user's physical characteristics, or combinations thereof.

28. The method of claim 23, wherein gathering user information comprises gathering eye-hand coordination information from the user, followed by gathering musical idea ability information from the user, followed by gathering instrument tonal preferences information from the user.

29. The method of claim 23, further comprising quantifying the user information.

30. The method of claim 29, wherein generating the musical instrument compatibility recommendation comprises applying one or more recommendation rules to the quantified user information.

31. The method of claim 23, wherein the musical instrument compatibility recommendation comprises a recommendation discouraging the user from playing a musical instrument.

32. A system for assisting a first user in choosing a musical instrument, comprising:
gathering means for gathering user information from the first user;
recommending means for generating a first musical instrument compatibility recommendation based on the user information; and
providing means for providing the first musical instrument compatibility recommendation to the first user.

33. The system of claim 32, wherein the first user is located at a first remote location and the gathering means is located at a central location.

34. The system of claim 33, wherein the gathering means is configured to gather user information from the first user via a network.

35. The system of claim 33, wherein the gathering means is configured to gather user information from a second user and the providing means is configured to provide a second musical instrument compatibility recommendation to the second user, the second user being located at a second remote location.

36. The system of claim 32, wherein the gathering means comprises means for gathering eye-hand coordination, means for gathering musical idea ability information, means for gathering instrument tonal preferences information, means for gathering inner pulse information, and means for gathering personal information.

37. The system of claim 36, wherein the musical idea ability information comprises information related to the user's grasp of timbre, pitch, rhythm, volume, or combinations thereof.

38. The system of claim 36, wherein the personal information comprises information related to the user's personality or character, the user's environment, the user's physical characteristics, or combinations thereof.

39. The system of claim 32, further comprising quantifying means for quantifying the user information, thereby creating quantified user information.

40. The system of claim 39, wherein the generating means is configured to apply one or more recommendation rules to the quantified user information.
